(19) United States
(12) Patent Application Publication
(10) Pub. No.: US 2025/0078437 A1
(43) Pub. Date: Mar. 6, 2025

(54) SEMI-AUTOMATIC PERCEPTION ANNOTATION SYSTEM

(71) Applicant: QUALCOMM Incorporated, San Diego, CA (US)

(72) Inventors: Julia Kabalar, München (DE); Mireille Lucette Laure Gregoire, Stuttgart (DE); Hazem Ahmed Mohamed Mohamed Rashed, Kronach (DE); Dorel Mircea Coman, München (DE); Nirnai Ach, Munich (DE); Kiran Bangalore Ravi, Paris (FR); Senthil Kumar Yogamani, San Diego, CA (US)

(21) Appl. No.: 18/804,633

(22) Filed: Aug. 14, 2024

Related U.S. Application Data
(60) Provisional application No. 63/580,659, filed on Sep. 5, 2023.

(51) Int. Cl. G06V 10/25; G06T 7/70; G06V 20/58; G06V 20/70

(52) U.S. Cl. CPC G06V 10/25; G06T 7/70; G06V 20/58; G06V 20/70; G06T 2207/20104; G06T 2207/30242; G06T 2207/30252

(57) ABSTRACT

A method for selecting one or more Regions of Interest (RoIs) for human annotations includes obtaining sensor data generated by one or more sensors of a vehicle; applying at least one class-agnostic heuristic function to the sensor data to determine a presence and an approximate position of one or more objects in an RoI of the sensor data; selecting one or more RoIs having proposed annotations for the one or more objects for refinement by an annotator; and outputting the one or more selected RoIs.

This application claims the benefit of U.S. Provisional Patent Application No. 63/580,659, filed Sep. 5, 2023, the entire content of which is incorporated by reference herein.

### TECHNICAL FIELD

This disclosure relates to machine learning in computing systems.

### BACKGROUND

Artificial intelligence (AI) and machine learning (ML), particularly deep neural networks (DNNs), are increasingly used by many autonomous and semi-autonomous vehicles. DNNs analyze data from sensors like cameras and LiDAR to create a real-time perception of the surroundings. DNNs allow the vehicle to identify objects like pedestrians, cars, traffic lights, and lane markings.

Advanced Driver-Assistance Systems (ADAS) are designed to support the driver, not replace them. ADAS may use sensors and software to warn drivers of potential hazards and can even take corrective actions like automatic emergency braking, for example.

### SUMMARY

In general, this disclosure describes techniques for a semi-automated approach to selecting perception data in a ML model. In some instances, the disclosed system may use AI to automatically identify and pre-select potentially interesting regions of the data (images or point clouds) for annotation. Then, a human reviewer could review these pre-selected regions and decide which ones are useful for training the machine learning model. The techniques of the present disclosure provide a semi-automatic auto-labeling review selector capability to select key Regions of Interest (RoIs), which may be faster and cheaper as compared to manual selection. The human reviewer may focus their time on the most interesting or challenging cases, improving efficiency.

In one example, a method for selecting one or more Regions of Interest (RoIs) for human annotations includes obtaining sensor data generated by one or more sensors of a vehicle; applying at least one class-agnostic heuristic function to the sensor data to determine a presence and an approximate position of one or more objects in an RoI of the sensor data; selecting one or more RoIs having proposed annotations for the one or more objects for refinement by an annotator; and outputting the one or more selected RoIs.

In another example, an apparatus for selecting one or more Regions of Interest (RoIs) for human annotations includes a memory for storing sensor data; and processing circuitry in communication with the memory. The processing circuitry is configured to obtain the sensor data generated by one or more sensors of a vehicle. The processing circuitry is also configured to apply at least one class-agnostic heuristic function to the sensor data to determine a presence and an approximate position of one or more objects in an RoI of the sensor data and to select one or more RoIs having proposed annotations for the one or more objects for refinement by an annotator. Finally, the processing circuitry is configured to output the one or more selected RoIs.

In yet another example, non-transitory computer-readable storage media having instructions encoded thereon, the instructions configured to cause processing circuitry to: obtain the sensor data generated by one or more sensors of a vehicle and to apply at least one class-agnostic heuristic function to the sensor data to determine a presence and an approximate position of one or more objects in an RoI of the sensor data. Additionally, the instructions are configured to cause the processing circuitry to select one or more RoIs having proposed annotations for the one or more objects for refinement by an annotator and to output the one or more selected RoIs.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a diagram of an example vehicle, in accordance with the techniques of this disclosure.

FIG. 2 is a block diagram illustrating an example computing system that may perform the techniques of this disclosure.

FIG. 3 is a block diagram illustrating a review selector in accordance with the techniques of this disclosure.

FIG. 4 is a block diagram illustrating a region of interest (RoI) select mode without a pretrained model in accordance with the techniques of this disclosure.

FIG. 5 is a block diagram illustrating an annotation review mode with a pretrained model in accordance with the techniques of this disclosure.

FIG. 6 is a block diagram illustrating a RoI selector mode of operation in accordance with the techniques of this disclosure.

FIG. 7 is a block diagram illustrating a model pre-annotation and RoI selector review mode in accordance with the techniques of this disclosure.

FIG. 8 is a block diagram illustrating class-agnostic heuristic functions in accordance with techniques of this disclosure.

FIG. 9 illustrates a sample image and class-agnostic objectness based RoI proposal in accordance with the techniques of this disclosure.

FIG. 10 is a block diagram of class-agnostic objectness based detection processing in accordance with the techniques of this disclosure.

FIG. 11 is a block diagram illustrating a high definition (HD) map-based RoI technique in accordance with the techniques of this disclosure.

FIG. 12 illustrates a sample image using multi-modal embeddings in accordance with the techniques of this disclosure.

FIG. 13 illustrates a sample image using 3D scene flow estimation in accordance with the techniques of this disclosure.

FIG. 14 illustrates a sample image using occupancy estimation in accordance with the techniques of this disclosure.

FIG. 15 illustrates a sample image of a rejection scenario.

FIG. 16 illustrates a sample image of another rejection scenario.

FIG. 17 is a block diagram illustrating external data annotator processing in accordance with the techniques of this disclosure.

FIG. 18 is a flowchart illustrating an example method for semi-automatic perception annotation in accordance with the techniques of this disclosure.

### DETAILED DESCRIPTION

ADAS systems use a combination of sensors (cameras, radar, LiDAR) and software to enhance a driver's awareness and improve vehicle safety. An ADAS may warn drivers of potential hazards like, but not limited to, lane departures, blind spot objects, or impending collisions. In some cases, the ADAS may even take corrective actions like automatic emergency braking. At the core of many ADAS features lies ML, particularly models that may analyze sensor data. For example, an ADAS may use an ML model to analyze a sequence of images from a forward-facing camera. Based on what the model detects in the images, the model may alert the driver of a potential obstacle or initiate automatic braking.

Deep learning models are like students that learn from examples. In this case, the examples are data points with labels that tell the model what the model is looking at. For instance, an image of a car needs a label indicating “car” for the model to recognize it in future scenarios. Annotating data often involves humans labeling the data points with relevant information.

However, manually annotating large datasets is expensive and time-consuming. Automatic labeling pipelines are systems that can automatically label data points, reducing the need for manual work. Automated labeling allows for collecting large datasets more efficiently, which may be important for training robust DNN models. While automatic labeling scales well, more data is not necessarily always better. Training DNNs on “easy” or redundant data (information the model already knows) is a waste of resources. Such training may increase annotation costs without significantly improving model performance. The preferable scenario is to focus on “hard examples” that challenge the model and help it learn. One approach to achieve such scenario is to use active learning where a human annotator works with the model in a loop.

For an ML model to perform well, ML models are trained on a vast amount of data that represents real-world driving scenarios. ML models are like students that learn from examples. In this case, the examples are data points with labels. The training data may include, but is not limited to, images, radar readings, and LiDAR scans along with corresponding information about the driving environment (cars ahead, pedestrians crossing, etc.). Training data is typically annotated. Annotating data often involves humans labeling the data points with relevant information. In other words, training data may need manual labeling of the data to tell the ML model what the model is looking at. For example, an image of a vehicle on the road needs a label indicating “vehicle” so the model may learn to recognize vehicles in future scenarios. Annotating massive datasets by humans may be a cumbersome, time-consuming, and expensive task. Such task may require labeling every object in every frame of video from a camera of a vehicle.

Manual data annotation requires human labor, quality control, and may be a significant bottleneck in the development process. The present disclosure discusses new techniques to automate parts of the annotation process. The disclosed system may use model-independent heuristic functions to analyze images or point clouds. The heuristic functions are like sets of rules that can identify potential objects based on factors like shape, color, and size.

The disclosed system may then use the aforementioned heuristics to propose potential objects and their approximate locations. If an existing ML model is available, the system could combine its predictions with the heuristic outputs. Ultimately, only the most “interesting” objects (uncertain cases, potentially occluded objects) would be sent to human annotators for final verification and labeling. By automating initial proposals and focusing human effort on the most challenging cases, the disclosed techniques aim to significantly reduce the amount of data requiring manual annotation. The disclosed techniques translate to lower development costs for ADAS systems. The techniques described herein also define an interface for use by human annotators. This interface may clearly communicate what needs to be labeled (specific regions, object aspects, etc.).

Additionally, the disclosed system may allow for feedback from annotators to improve the performance of the automated object selector and model prediction refiner. This feedback loop may help the disclosed system become more accurate over time. The preferable scenario is to train the model on challenging data (“hard examples”) that help the model learn and improve. Active learning is a technique for achieving this. In active learning technique, a human may work with the model in a loop.

Advantageously, reducing manual annotation effort may lead to significant cost savings in terms of both money and resources. By reducing the time and resources needed for annotation, companies may develop and deploy self-driving technology faster. Less human annotation may translate to lower overall development costs. Lower development costs may make autonomous vehicles more accessible and commercially viable. If the annotation burden is lessened, companies may potentially handle much larger datasets. Larger datasets may lead to more robust and accurate AI models for vehicles. The disclosed active learning technique may focus on strategically selecting the most informative data points for human annotation. Active learning may allow for better model development with less overall labeling. The more data the system has, the better the model may generalize and perform in unseen situations. However, not all data is created equal. Including “easy” or redundant data (images/point clouds the model already understands well) may increase the cost of annotation. Annotating unnecessary data may take time and resources without significantly improving the performance of the model, such as, for example, labeling hundreds of images of clear blue skies for a model that already recognizes them perfectly.

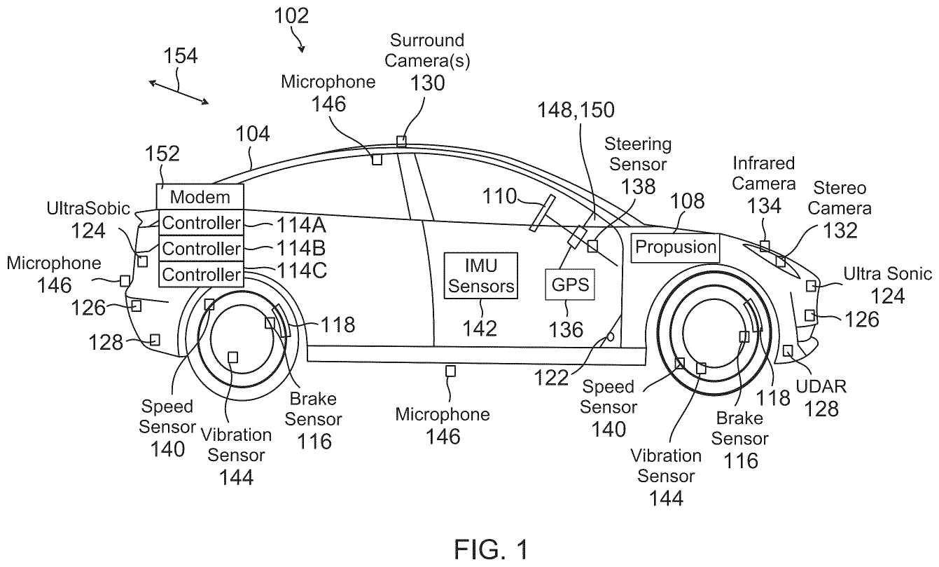

FIG. 1 shows an example vehicle 102. Vehicle 102 in the example shown may comprise a passenger vehicle such as a car or truck that can accommodate a human driver and/or human passengers. In an aspect, vehicle 102 may comprise an autonomous vehicle, semi-autonomous vehicle and/or an ADAS system. Vehicle 102 may include a vehicle body 104 suspended on a chassis, in this example comprised of four wheels and associated axles. A propulsion system 108 such as an internal combustion engine, hybrid electric power plant, or even all-electric engine may be connected to drive some or all of the wheels via a drive train, which may include a transmission (not shown). A steering wheel 110 may be used to steer some or all of the wheels to direct vehicle 102 along a desired path when the propulsion system 108 is operating and engaged to propel the vehicle 102. Steering wheel 110 or the like may be optional for Level 5 implementations. One or more controllers 114A-114C (a controller 114) may provide autonomous capabilities in response to signals continuously provided in real-time from an array of sensors, as described more fully below.

Each controller 114 may be essentially one or more onboard computers that may be configured to perform deep learning and/or artificial intelligence functionality and output autonomous operation commands to self-drive vehicle 102 and/or assist the human vehicle driver in driving. Each vehicle may have any number of distinct controllers for functional safety and additional features. For example, controller 114A may serve as the primary computer for autonomous driving functions, controller 114B may serve as a secondary computer for functional safety functions, controller 114C may provide artificial intelligence functionality for in-camera sensors, and controller 114D (not shown) may provide infotainment functionality and provide additional redundancy for emergency situations.

Controller 114 may send command signals to operate vehicle brakes 116 via one or more braking actuators 118, operate steering mechanism via a steering actuator, and operate propulsion system 108 which also receives an accelerator/throttle actuation signal 122. Actuation may be performed by methods known to persons of ordinary skill in the art, with signals typically sent via the Controller Area Network data interface (“CAN bus”)—a network inside modern cars used to control brakes, acceleration, steering, windshield wipers, and the like. The CAN bus may be configured to have dozens of nodes, each with its own unique identifier (CAN ID). The bus may be read to find steering wheel angle, ground speed, engine RPM, button positions, and other vehicle status indicators. The functional safety level for a CAN bus interface is typically Automotive Safety Integrity Level (ASIL) B. Other protocols may be used for communicating within a vehicle, including FlexRay and Ethernet.

In an aspect, an actuation controller may be obtained with dedicated hardware and software, allowing control of throttle, brake, steering, and shifting. The hardware may provide a bridge between the vehicle's CAN bus and the controller 114, forwarding vehicle data to controller 114 including the turn signal, wheel speed, acceleration, pitch, roll, yaw, Global Positioning System (“GPS”) data, tire pressure, fuel level, sonar, brake torque, and others. Similar actuation controllers may be configured for any other make and type of vehicle, including special-purpose patrol and security cars, robo-taxis, long-haul trucks including tractor-trailer configurations, tiller trucks, agricultural vehicles, industrial vehicles, and buses.

Controller 114 may provide autonomous driving outputs in response to an array of sensor inputs including, for example: one or more ultrasonic sensors 124, one or more RADAR sensors 126, one or more LiDAR sensors 128, one or more surround cameras 130 (typically such cameras are located at various places on vehicle body 104 to image areas all around the vehicle body), one or more stereo cameras 132 (in an aspect, at least one such stereo camera may face forward to provide object recognition in the vehicle path), one or more infrared cameras 134, GPS unit 136 that provides location coordinates, a steering sensor 138 that detects the steering angle, speed sensors 140 (one for each of the wheels), an inertial sensor or inertial measurement unit (“IMU”) 142 that monitors movement of vehicle body 104 (this sensor can be for example an accelerometer(s) and/or a gyro-sensor(s) and/or a magnetic compass(es)), tire vibration sensors 144, and microphones 146 placed around and inside the vehicle. Other sensors may be used, as is known to persons of ordinary skill in the art.

Controller 114 may also receive inputs from an instrument cluster 148 and may provide human-perceptible outputs to a human operator via human-machine interface (“HMI”) display(s) 150, an audible annunciator, a loudspeaker and/or other means. In addition to traditional information such as velocity, time, and other well-known information, HMI display 150 may provide the vehicle occupants with information regarding maps and vehicle's location, the location of other vehicles (including an occupancy grid) and even the Controller's identification of objects and status. For example, HMI display 150 may alert the passenger when the controller has identified the presence of a stop sign, caution sign, or changing traffic light and is taking appropriate action, giving the vehicle occupants peace of mind that the controller 114 is functioning as intended.

In an aspect, instrument cluster 148 may include a separate controller/processor configured to perform deep learning and artificial intelligence functionality.

Vehicle 102 may collect data that is preferably used to help train and refine the neural networks used for autonomous driving. The vehicle 102 may include modem 152, preferably a system-on-a-chip that provides modulation and demodulation functionality and allows the controller 114 to communicate over the wireless network 154. Modem 152 may include an RF front-end for up-conversion from baseband to RF, and down-conversion from RF to baseband, as is known in the art. Frequency conversion may be achieved either through known direct-conversion processes (direct from baseband to RF and vice-versa) or through super-heterodyne processes, as is known in the art. Alternatively, such RF front-end functionality may be provided by a separate chip. Modem 152 preferably includes wireless functionality substantially compliant with one or more wireless protocols such as, without limitation: LTE, WCDMA, UMTS, GSM, CDMA2000, or other known and widely used wireless protocols.

It should be noted that, compared to sonar and RADAR sensors 126, cameras 130-134 may generate a richer set of features at a fraction of the cost. Thus, vehicle 102 may include a plurality of cameras 130-134, capturing images around the entire periphery of the vehicle 102. Camera type and lens selection depends on the nature and type of function. The vehicle 102 may have a mix of camera types and lenses to provide complete coverage around the vehicle 102; in general, narrow lenses do not have a wide field of view but can see farther. All camera locations on the vehicle 102 may support interfaces such as Gigabit Multimedia Serial link (GMSL) and Gigabit Ethernet.

In an aspect, a controller 114 may obtain sensor data generated by one or more sensors 128-134 of the vehicle 102. Next, controller 114 may apply at least one class-agnostic heuristic function to the sensor data to determine a presence and an approximate position of one or more objects in an RoI of the sensor data. In addition, controller 114 may select one or more RoIs having proposed annotations for the one or more objects for refinement by a human annotator. Finally, controller 114 may output the one or more selected RoIs.

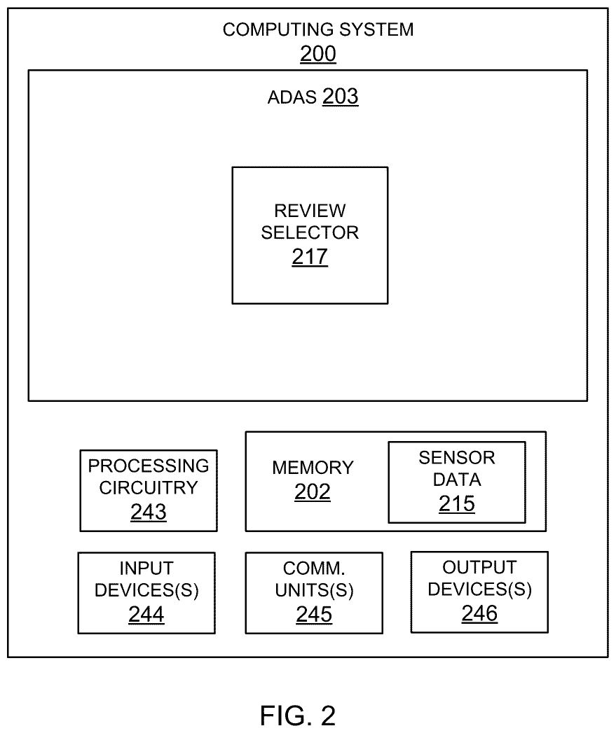

FIG. 2 is a block diagram illustrating an example computing system that may perform the techniques of this disclosure. As shown, computing system 200 comprises processing circuitry 243 and memory 202 for executing ADAS 203, including review selector 217, which may represent an example instance of any controller 114 described in this disclosure, such as controller 114 of FIG. 1.

Computing system 200 may be implemented as any suitable external computing system accessible by controller 114, such as one or more server computers, workstations, laptops, mainframes, appliances, embedded computing systems, cloud computing systems, High-Performance Computing (HPC) systems (i.e., supercomputing systems) and/or other computing systems that may be capable of performing operations and/or functions described in accordance with one or more aspects of the present disclosure. In some examples, computing system 200 may represent a cloud computing system, server farm, and/or server cluster (or portion thereof) that provides services to client devices and other devices or systems. In other examples, computing system 200 may represent or be implemented through one or more virtualized compute instances (e.g., virtual machines, containers, etc.) of a data center, cloud computing system, server farm, and/or server cluster. In an aspect, computing system 200 is disposed in vehicle 102.

The techniques described in this disclosure may be implemented, at least in part, in hardware, software, firmware or any combination thereof. For example, various aspects of the described techniques may be implemented within processing circuitry 243 of computing system 200, which may include one or more of a microprocessor, a controller, a digital signal processor (DSP), an application specific integrated circuit (ASIC), a field-programmable gate array (FPGA), or equivalent discrete or integrated logic circuitry, or other types of processing circuitry. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

In another example, computing system 200 comprises any suitable computing system having one or more computing devices, such as desktop computers, laptop computers, gaming consoles, smart televisions, handheld devices, tablets, mobile telephones, smartphones, etc. In some examples, at least a portion of computing system 200 is distributed across a cloud computing system, a data center, or across a network, such as the Internet, another public or private communications network, for instance, broadband, cellular, Wi-Fi, ZigBee, Bluetooth® (or other personal area network—PAN), Near-Field Communication (NFC), ultrawideband, satellite, enterprise, service provider and/or other types of communication networks, for transmitting data between computing systems, servers, and computing devices.

Memory 202 may comprise one or more storage devices. One or more components of computing system 200 (e.g., processing circuitry 243, memory 202, etc.) may be interconnected to enable inter-component communications (physically, communicatively, and/or operatively). In some examples, such connectivity may be provided by a system bus, a network connection, an inter-process communication data structure, local area network, wide area network, or any other method for communicating data. Processing circuitry 243 of computing system 200 may implement functionality and/or execute instructions associated with computing system 200. Examples of processing circuitry 243 include microprocessors, application processors, display controllers, auxiliary processors, one or more sensor hubs, and any other hardware configured to function as a processor, a processing unit, or a processing device. Computing system 200 may use processing circuitry 243 to perform operations in accordance with one or more aspects of the present disclosure using software, hardware, firmware, or a mixture of hardware, software, and firmware residing in and/or executing at computing system 200. The one or more storage devices of memory 202 may be distributed among multiple devices.

Memory 202 may store information for processing during operation of computing system 200. In some examples, memory 202 comprises temporary memories, meaning that a primary purpose of the one or more storage devices of memory 202 is not long-term storage. Memory 202 may be configured for short-term storage of information as volatile memory and therefore not retain stored contents if deactivated. Examples of volatile memories include random-access memories (RAM), dynamic random-access memories (DRAM), static random-access memories (SRAM), and other forms of volatile memories known in the art. Memory 202, in some examples, may also include one or more computer-readable storage media. Memory 202 may be configured to store larger amounts of information than volatile memory. Memory 202 may further be configured for long-term storage of information as non-volatile memory space and retain information after activate/off cycles. Examples of non-volatile memories include magnetic hard disks, optical discs, Flash memories, or forms of electrically programmable read only memories (EPROM) or electrically erasable and programmable (EEPROM) read only memories.

Memory 202 may store program instructions and/or data associated with one or more of the modules described in accordance with one or more aspects of this disclosure. For example, memory 202 may store sensor data 215 received from one or more sensors 128-134 of the vehicle 102, as well as instructions of ADAS 203, including review selector 217.

Processing circuitry 243 and memory 202 may provide an operating environment or platform for one or more modules or units (e.g., ADAS 203, including review selector 217, etc.), which may be implemented as software, but may in some examples include any combination of hardware, firmware, and software. Processing circuitry 243 may execute instructions and the one or more storage devices, e.g., memory 202, may store instructions and/or data of one or more modules. The combination of processing circuitry 243 and memory 202 may retrieve, store, and/or execute the instructions and/or data of one or more applications, modules, or software. The processing circuitry 243 and/or memory 202 may also be operably coupled to one or more other software and/or hardware components, including, but not limited to, one or more of the components illustrated in FIG. 2.

Processing circuitry 243 may execute ADAS 203, including review selector 217, using virtualization modules, such as a virtual machine or container executing on underlying hardware. One or more of such modules may execute as one or more services of an operating system or computing platform. Aspects of ADAS 203, including review selector 217, may execute as one or more executable programs at an application layer of a computing platform.

One or more input device(s) 244 of computing system 200 may generate, receive, or process input. Such input may include input from a keyboard, pointing device, voice responsive system, video camera, biometric detection/response system, button, sensor, mobile device, control pad, microphone, presence-sensitive screen, network, or any other type of device for detecting input from a human or machine.

One or more output device(s) 246 may generate, transmit, or process output. Examples of output are tactile, audio, visual, and/or video output. Output devices 246 may include a display, sound card, video graphics adapter card, speaker, presence-sensitive screen, one or more universal serial bus (USB) interfaces, video and/or audio output interfaces, or any other type of device capable of generating tactile, audio, video, or other output. Output devices 246 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating tactile, audio, and/or visual output. In some examples, computing system 200 may include a presence-sensitive display that may serve as a user interface device that operates both as one or more input devices 244 and one or more output devices 246.

One or more communication units 245 of computing system 200 may communicate with devices external to computing system 200 (or among separate computing devices of computing system 200) by transmitting and/or receiving data, and may operate, in some respects, as both an input device and an output device. In some examples, communication units 245 may communicate with other devices over a network. In other examples, communication units 245 may send and/or receive radio signals on a radio network such as a cellular radio network. Examples of communication units 245 include a network interface card (e.g., such as an Ethernet card), an optical transceiver, a radio frequency transceiver, a GPS receiver, or any other type of device that can send and/or receive information. Other examples of communication units 245 may include Bluetooth®, GPS, 3G, 4G, 5G and Wi-Fi® radios found in mobile devices as well as Universal Serial Bus (USB) controllers and the like.

In the example of FIG. 2, ADAS 203 may rely on various sensors to gather information about the surroundings of the vehicle 102. These can include cameras, radar, LiDAR (Light Detection and Ranging), as described herein. ADAS 203 may receive input data. Review selector 217 may generate output data. The input data and output data may contain various types of information. For example, the input data may include, but is not limited to, camera/LiDAR/INS sequences, HD maps, and so on. The output data may include generated RoI proposal (mask/box), and so on. The output data may be used by an external data annotation unit.

ADAS 203 may use model-independent heuristic functions to analyze images or point clouds. In an aspect, the disclosed techniques may use review selector 217 to automatically identify and pre-select potentially interesting regions of the sensor data 215 (images or point clouds).

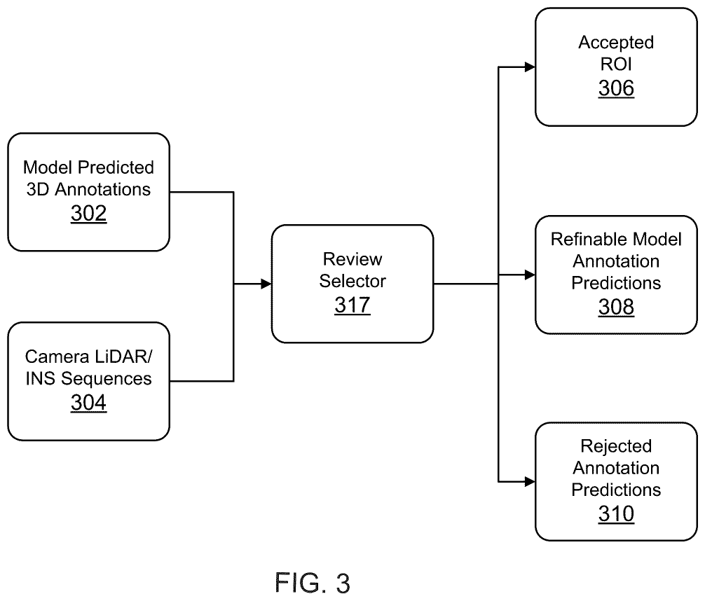

FIG. 3 is a block diagram illustrating a review selector 317 in accordance with the techniques of this disclosure. Review selector 317 is an example of review selector 217 of FIG. 2. Review selector 317 may also be executed by any computing system, either within vehicle 102 or apart from vehicle 102. As noted above, training machine learning models used in vehicles may require a large amount of data annotated with information about the environment (cars, pedestrians, etc.). Annotating every detail in every camera frame or LiDAR scan may be very time-consuming and expensive. Review selector 317 may provide for identifying a region of interest (RoI) in camera LIDAR/inertial navigation system (INS) sequences, referred to hereinafter as sensor data 304, of camera images for annotators to optimize annotation cost. As used herein, the term RoI refers to a specific area of the sensor data 215 that may be considered important for the machine learning model to learn from. Review selector 317 may focus on only identified RoIs. In one non-limiting example, the road itself might be an RoI, while a parked car on the sidewalk may not be. By focusing on RoIs, review selector 317 may reduce the amount of data that human annotators need to review, saving time and cost.

Review selector 317 may also better ensure annotators spend their time on the most relevant parts of the data, leading to more accurate annotations. Review selector 317 may identify different types of RoIs depending on the task. For example, review selector 317 may focus on specific areas/regions like the road. In an aspect, review selector 317 may identify specific objects (cars, pedestrians) and may create a mask around them for annotation. Review selector 317 may also be used for reviewing pre-existing annotations or labels generated by other tools. Review selector 317 may flag objects that ADAS 203 is unsure about, allowing human review and correction. If the pre-labeling process encounters issues, review selector 317 may direct human attention to those specific objects. For review/pre-labeling corrections, it may be possible to review only a single object which has been flagged as uncertain or problematic.

In one scenario, review selector 317 may omit use of a pretrained model but may instead support alternative class-agnostic metrics. An annotator may reduce annotation time by focusing within a RoI instead of annotating the entire image. Review selector 317 may use statistical analysis of the data to identify areas with high variation or unusual features, which could be potential RoIs requiring closer inspection. Review selector 317 may use class-agnostic metrics. As used herein, the term “class-agnostic metrics” refers to the metrics used to identify RoIs that are not specific to any particular class of object (cars, pedestrians, etc.). Following are some possible examples of class-agnostic metrics. Review selector 317 may identify areas with significant motion as potential RoIs, as they might contain moving objects. Changes in depth within the LiDAR data may indicate interesting areas, such as, but not limited to, objects on the road or obstacles. Review selector 317 may employ techniques used to identify visually interesting regions in images to highlight potential RoIs. By using these alternative metrics to identify RoIs, review selector 317 may allow human annotators to focus on specific areas of the image or LiDAR scan. This can significantly reduce annotation time compared to manually reviewing the entire dataset. Annotators only need to focus on the highlighted RoIs, which are likely to contain the most important information for the machine learning model. Since review selector 317 may pre-select potentially interesting areas, annotators may not need to spend time searching for relevant objects in the entire data.

In another scenario, as shown in FIG. 3, review selector 317 may use a pretrained model and alternative class-agnostic metrics. The pretrained model has already been trained on a large dataset of images and LiDAR scans, allowing it to identify potential objects in new data. The pre-trained model may analyze the data (camera images, LiDAR scans) and may generate predictions about what objects might be present. These predictions may include, but are not limited to, bounding boxes (areas around objects) or 3D annotations (location and shape information) for these potential objects. Review selector 317 may not solely rely on the predictions of the pre-trained model. Review selector 317 may also incorporate alternative class-agnostic metrics.

The class-agnostic metrics, as mentioned earlier, are not specific to any particular object class. Here, the class-agnostic metrics may be used to assess the confidence or accuracy of the pre-trained model's predictions. Examples of the class-agnostic metrics may include, but are not limited to, motion detection (for moving objects), depth changes (for objects with different depths), or saliency detection (for visually interesting areas). Based on the predictions of the pre-trained model and based on the alternative metrics, review selector 317 may make decisions about each potential object. If the prediction of the model and the metrics all suggest a high level of confidence, review selector 317 may accept the pre-labeled region 306 (bounding box or 3D annotation) without human intervention. In cases where the confidence is lower or the metrics indicate potential issues, review selector 317 may forward refinable model annotations 308 to a human annotator for further refinement. The human may then adjust the pre-labeled region or provide additional information. If both the model and the metrics show low confidence, review selector 317 may reject the prediction 310 entirely. By filtering and pre-labeling data using the pre-trained model and alternative metrics, review selector 317 may significantly reduce the work required by human annotators. Annotators only need to focus on the RoIs identified by review selector 317 and refine existing predictions instead of starting from scratch for every object.

In addition to identifying RoIs, review selector 317 may also predict attributes of objects within those regions. For example, review selector 317 may predict not only that there is a car in the image, but also that the car is red and has four doors. Review selector 317 may predict attribute presence using independent tasks and by using occlusion and dynamic attributes. Review selector 317 may use separate models or algorithms to predict each attribute. For instance, one model may focus on color, another on size, and another on the number of doors. Review selector 317 may also factor in occlusion (when objects are hidden) and dynamic attributes. Occlusion may be important because occlusion may affect how well attributes can be predicted. Dynamic attributes may change over time (e.g., a turn signal blinking). Review selector 317 may receive feedback from annotators to improve proposals. Specifically, annotators may provide weak supervision of how complete the proposed regions were in terms of false negatives. The term “weak supervision,” as used herein, means the feedback may not pinpoint specific missing information but rather may indicate if there were any relevant attributes the review selector 317 missed within the RoI. Such feedback may help review selector 317 to learn from its mistakes. Over time, review selector 317 may use this information to improve the accuracy of its attribute predictions, especially for occluded objects or dynamic attributes.

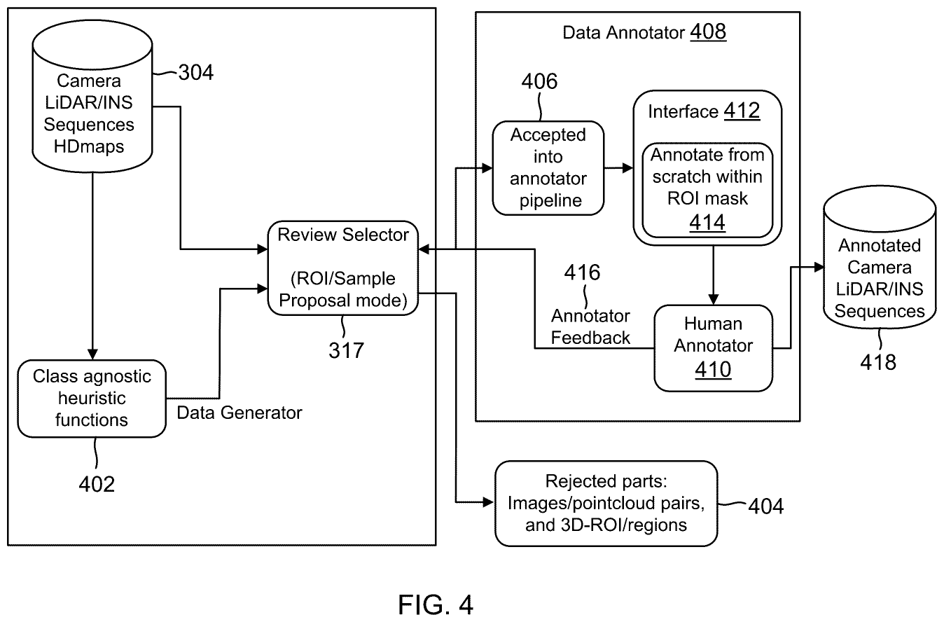

FIG. 4 is a block diagram illustrating a region of interest (RoI) select mode without a pretrained model example in accordance with the techniques of this disclosure. FIG. 4 illustrates that review selector 317 may use different types of data as input to identify RoI for data annotation tasks. In one example, input data may include camera sensor data 304. Camera sequences may include images captured by a camera mounted on the vehicle (e.g., surround camera 130), providing visual information about the surroundings. LiDAR sensors 128 use lasers to create 3D point clouds of the environment, offering detailed information about object distance and depth. INS system may provide data on the orientation (heading, pitch, roll) and movement (acceleration, velocity) of vehicle. High Definition maps (HDmaps) are pre-existing digital maps containing high-resolution details about the road network, including, but not limited to, lane markings, traffic signs, and potentially even curbs and sidewalks. HDmaps may provide valuable context for the camera and LiDAR data, helping the review selector 317 understand the overall layout of the environment.

Class-agnostic heuristic functions 402 may be a set of rules or algorithms that do not rely on pre-identifying specific object classes (cars, pedestrians, etc.). Heuristic functions 402 may analyze features like edges in images or normals in point clouds to identify potential objects without classifying them (i.e., without classifying an object as a car or a pedestrian). Heuristic functions 402 may identify potential objects based on their geometric shapes in the camera images or LiDAR point clouds. Heuristic functions 402 may use color variations to detect objects that might stand out from the background. Heuristic functions 402 may detect areas with significant motion in the camera sequences, which could indicate moving objects. Review selector 317 may leverage this combination of data to identify regions in the camera, LiDAR, and INS sequences that are most likely to contain important information for training the machine learning model. HDmaps may provide context about the road layout, helping the review selector 317 to focus on relevant areas like lanes and intersections. LiDAR data may provide depth information, while camera data may offer visual cues. Class-agnostic heuristic functions 402 may use these cues to identify potential objects based on shape, color, or motion. By combining all this information, review selector 317 may identify RoIs that are likely to contain objects of interest for the machine learning model (e.g., cars, pedestrians, traffic signs) or areas with complex scenarios (e.g., intersections with multiple lanes).

As shown in FIG. 4, review selector 317 may output two categories of data: rejected parts 404 and accepted parts (accepted data) 406. Rejected parts 404 may be images/point cloud pairs and 3D regions that the review selector 317 may deem irrelevant or the ones that may not require annotation. Accepted parts 406 may be images/point cloud pairs and 3D regions considered important and that may be sent to the annotation pipeline. The accepted data 406 may be fed into an annotation pipeline managed by external data annotation units 408, which in turn may be managed by a third party (e.g., data annotation companies). Human annotators 410 may refine existing 3D regions proposed by review selector 317. Human annotators 410 may annotate objects within the identified RoIs (e.g., labeled cars, pedestrians). Furthermore, human annotators 410 may provide additional information about the scene (traffic signs, weather conditions, and the like). In an aspect, the annotation pipeline may utilize an interface 412 connected to review selector 317. The interface 412 may allow annotators 410 to: view the RoIs identified by review selector 317 and annotate objects directly within the pre-defined 3D regions (RoI masks). The interface 412 may potentially even facilitate annotations from scratch 414 within the RoI if needed. Human annotators 410 may review and annotate the data within the interface 412. Human annotators 410 may also provide feedback 416 to review selector 317, potentially indicating: issues with the proposed RoIs. Such feedback 416 may help improve the performance of review selector 317 over time. The final output of the process illustrated in FIG. 4 may be the annotated Camera/LiDAR/INS sequences 418, which may be used to train machine learning models for different navigation tasks by vehicles.

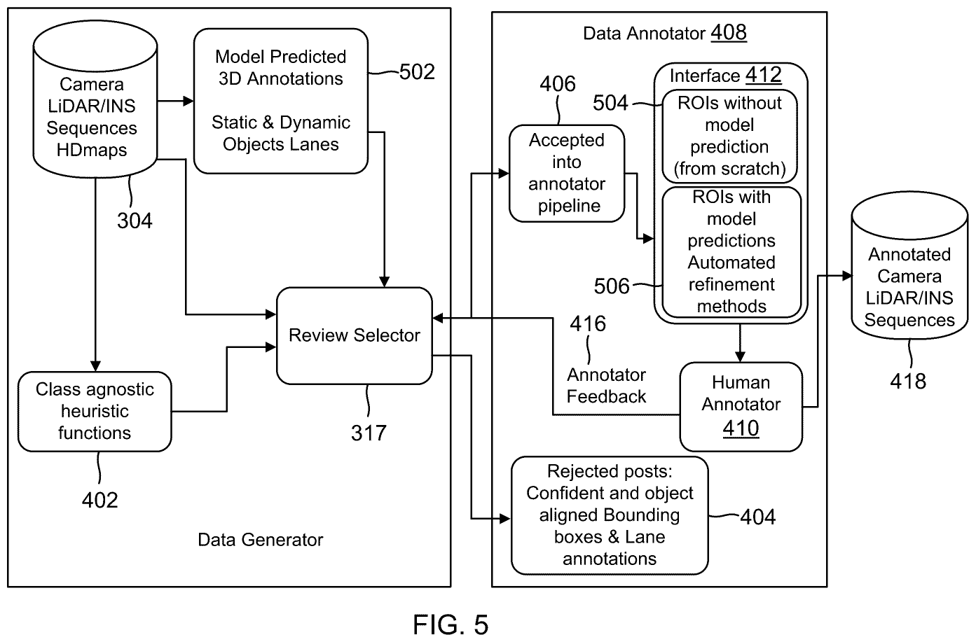

FIG. 5 is a block diagram illustrating an annotation review mode with a pretrained model in accordance with the techniques of this disclosure. As shown in FIG. 5, camera images of the surrounding environment, 3D point cloud data providing depth and distance information (LiDAR sequences), and INS data on vehicle movement and orientation (INS sequences) may be the raw data captured by the vehicle. HD maps may be pre-existing digital maps with detailed information about the road network, including lanes, traffic signs, etc. A pre-trained model may analyze the sensor data 304 and may predict the location and shape (3D annotations) of static objects (buildings, signs) and dynamic objects (cars, pedestrians) in the scene. These predictions may be a starting point for further refinement. Class-agnostic heuristic functions 402 are a set of rules or algorithms that analyze data. Heuristic functions 402 may analyze features like edges in images or normals in point clouds to identify potential objects without classifying them (i.e., without classifying an object as a car or a pedestrian). Heuristic functions 402 may identify potential objects based on their geometric shapes in the camera images or LiDAR point clouds. Heuristic functions 402 may use color variations to detect objects that might stand out from the background. A pre-trained model may analyze the sensor data 304 to generate initial 3D annotations 502 for objects (static and dynamic) and lanes. Review selector 317 may receive all the data inputs: sensor data 304, HDmaps, model-predicted 3D annotations (if applicable) 502, and class-agnostic heuristic functions 402. Review selector 317 may analyze all this information to identify RoIs that are likely to be important for training the machine learning model. The road layout contained in HDmaps may help focus on relevant areas. Model predicted annotations 502 may provide a starting point for object locations. Class-agnostic heuristics 402 may identify potential objects based on shape, color, and motion. Review selector 317 may output two categories: refined 3D annotations 504, and unnecessary data (rejected parts) 404. Refined 3D annotations may be potentially improved versions of the initial model predictions 506 or completely new annotations 504 based on the combined analysis. Unnecessary data (rejected parts) 404 may include images/point cloud pairs and regions deemed irrelevant for annotation and that are excluded.

Review selector 317 may output two types of rejected data with high confidence: bounding boxes and lane annotations. Such rejected bounding boxes may be boxes drawn around objects in the image/point cloud data that the review selector 317 may deem confidently identified and accurately aligned with the objects. If applicable, review selector 317 may also reject lane annotations the review selector 317 considers highly accurate. Essentially, review selector 317 may be confident these elements are correct and do not require human annotation. The remaining data, including, but not limited to, images/point cloud pairs and 3D regions, may be considered important and may be sent to the annotation pipeline for human review. The annotation pipeline may receive the accepted data from review selector 317. The pipeline may utilize an interface 412 connected to review selector 317. This interface 412 may allow human annotators 410 to: view RoIs identified by review selector 317 (potentially without any model predictions) and annotate objects entirely from scratch within these RoIs if needed. The interface 412 may further allow human annotators 410 to refine existing RoIs or bounding boxes suggested by review selector 317, especially for: uncertainties in model predictions (if used) and areas requiring more precise annotations. The interface 412 may also offer automated refinement methods to assist human annotators 410. These methods may include but are not limited to utilizing pre-trained models to suggest refinements to existing annotations, and/or employing class-agnostic heuristics (shape, color, motion) to further analyze potential objects within RoIs. Human annotators 410 may review the data, potentially using the automated refinement suggestions, and may perform annotations within the interface 412. Annotators 410 may provide feedback 416 to review selector 317, including, but not limited to: corrections to inaccurate RoIs or bounding boxes; issues with model predictions (if used). Such feedback 416 may help the review selector 317 to improve its performance over time. The final output of the process illustrated in FIG. 5 may be the annotated camera/LiDAR/INS sequences 418, incorporating human-verified annotations and feedback 416 for training machine learning models.

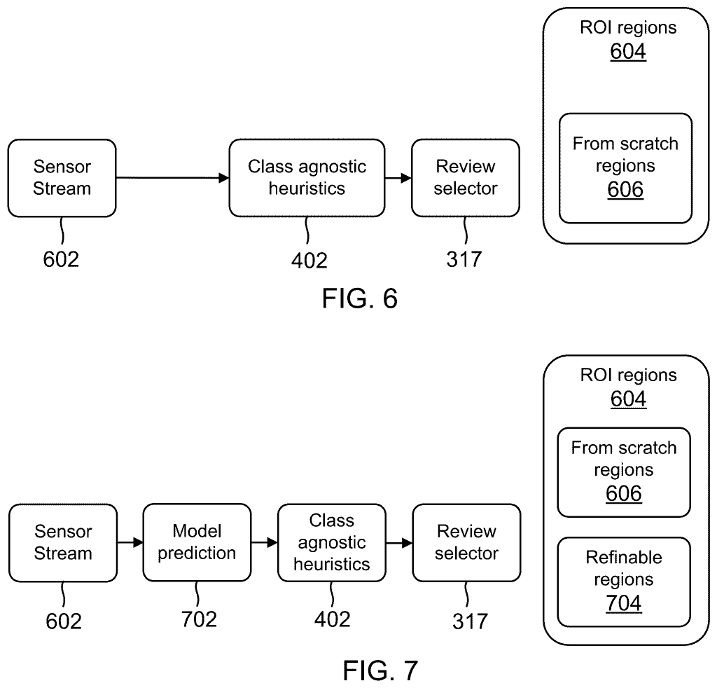

FIG. 6 is a block diagram illustrating a RoI selector mode in accordance with the techniques of this disclosure. In this mode of operation, review selector 317 may function as a Region of Interest (RoI) selector, focusing on identifying relevant areas in sensor data streams for human annotation without relying on pre-trained models. In this mode the input may be the continuous flow of data from the sensors of the vehicle. Sensor stream 602 may include images captured by the camera, point cloud data representing the depth and distance information within the environment. Sensor stream 602 may potentially include data from other sensors depending on the specific ADAS 203. Review selector 317 may apply class-agnostic heuristic functions 402 that analyze the sensor data based on factors like shape, color, and motion. Heuristic functions 402 may analyze features like edges in images or normals in point clouds to identify potential objects without classifying them (i.e., without classifying an object as a car or a pedestrian). Heuristic functions 402 may identify potential objects based on their geometric shapes in the camera images or LiDAR point clouds. In yet another example, review selector 317 may detect areas with significant motion in the camera stream, which could indicate moving objects. Based on the analysis of the sensor stream 602 using class-agnostic heuristic functions 402, the review selector 317 may identify potential RoI regions 604. The potential RoI regions 604 may likely contain important information for training the machine learning model, even without pre-trained object detection models. The primary output of this mode may be a set of RoIs identified entirely from scratch. The identified regions 606 may not be based on pre-existing object categories (cars, pedestrians, etc.) but rather on the raw sensor data analysis. This allows review selector 317 to be flexible and adaptable to various scenarios. The annotation process may start by focusing solely on the RoI regions 604 proposed by review selector 317. The RoI selector mode may specifically avoid using any pre-trained model predictions for object detection. In other words, human annotators may be responsible for identifying and labeling objects within the RoIs from scratch. By not relying on pre-trained models, the review selector 317 operating in the RoI selector mode may avoid potential biases the pre-trained models may have towards certain object classes. The RoI selector mode may allow for identifying unexpected objects or situations that pre-trained models might miss. Review selector 317 may pre-select potentially important areas, saving human annotators time by not needing to review the entire sensor stream 602.

FIG. 7 is a block diagram illustrating a model pre-annotation and RoI selector review mode in accordance with the techniques of this disclosure. In this mode of operation, review selector 317 may combine pre-trained model predictions 702 with RoI selection and human review for data annotation tasks. In this mode the input may be the continuous flow of data from the sensors of the vehicle. Sensor stream 602 may include images captured by the camera, point cloud data representing the depth and distance information within the environment. Sensor stream 602 may potentially include data from other sensors depending on the specific ADAS 203. A pre-trained model may analyze the sensor stream 602, potentially identifying objects and their locations in the data (bounding boxes or 3D annotations). This initial analysis may provide a starting point for further refinement. Review selector 317 may apply class-agnostic heuristic functions 402 that analyze the sensor data based on factors like shape, color, and motion. Heuristic functions 402 may analyze features like edges in images or normals in point clouds to identify potential objects without classifying them (i.e., without classifying an object as a car or a pedestrian). Heuristic functions 402 may identify potential objects based on their geometric shapes in the camera images or LiDAR point clouds. In yet another example, review selector 317 may detect areas with significant motion in the camera stream, which could indicate moving objects. In an aspect, the review selector 317 may combine the information from model pre-annotations (model predictions 702) and class-agnostic heuristic functions 402 to identify RoI regions 604. The identified RoI regions 604 may likely contain important information for training the machine learning model. In this mode, review selector 317 may output two categories of RoIs: “from scratch” regions 606 and “refinable” regions 704. The “from scratch” regions 606 may be the regions identified solely based on class-agnostic heuristic functions 402, independent of the pre-trained model's predictions 702. Refinable regions 704 may be the regions where the pre-trained model has proposed objects or locations. However, these predictions may require further refinement by human annotators. The annotation process focuses on the RoI regions 604 proposed by review selector 317. For the “from scratch” regions 606, human annotators may begin annotation entirely from scratch, identifying and labeling objects without any pre-existing suggestions. For refinable regions 704, human annotators may start with the model predictions 702 of the pre-trained model (bounding boxes or 3D annotations) within the RoI. Human annotators may accept the suggestions of the model if the suggestions appear accurate. Human annotators may refine the existing predictions to improve their accuracy. As yet another alternative, human annotators may completely disregard the suggestions of the model if these suggestions are incorrect. The mode of operation illustrated in FIG. 7 may take advantage of pre-trained models to potentially speed up the annotation process by providing initial object locations. This mode may incorporate human expertise to refine model predictions 702 and address potential biases or errors. Advantageously, review selector 317 may still identify unexpected objects or situations that the pre-trained model might miss using class-agnostic heuristic functions 402.

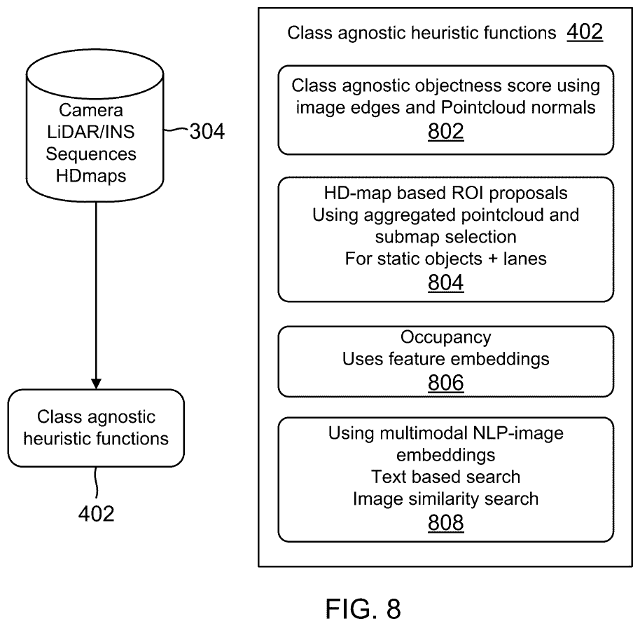

FIG. 8 is a block diagram illustrating class-agnostic heuristic functions in accordance with techniques of this disclosure.

As noted above, in one example, input data may include sensor data 304. Cameras may capture visual data like lanes, traffic lights, and signs. LiDAR may use lasers to create a 3D map of the environment, and INS may track the position and orientation of the vehicle. HDMaps may be very detailed maps that provide information about lanes, traffic signs, and other relevant objects. Review selector 317 may use class-agnostic heuristic functions 402. The class-agnostic heuristic functions 402 do not necessarily classify objects but may identify potential objects based on features like edges in images or normal in point clouds (3D data from LiDAR). In one example, class-agnostic heuristic functions 402 may use a class-agnostic objectness score 802. This score may indicate how likely it is that a particular area in the image or pointcloud contains an object, regardless of the object's type. HD maps 804 may be used to identify areas where objects are likely to be present, which helps focus object detection efforts on those areas. The 3D-scene flow estimation technique 806 may estimate how the 3D scene is changing over time, which may help identify moving objects. Occupancy grids 808 may represent the environment in 3D space, indicating whether each cell is likely to be occupied by an object or free. Feature embeddings techniques may convert data (like images or text) into a numerical representation that may be used for comparison. Multimodal NLP-image embeddings 810 may combine natural language processing (NLP) with image embeddings to understand relationships between text descriptions and images. The multimodal NLP-image embeddings 810 may be useful for tasks like searching for specific objects based on a text query. Text-based search may allow the ADAS 203 to search its surroundings for objects based on textual descriptions. Image similarity search may allow the ADAS 203 to search for objects in its surroundings that are similar to a reference image.

As described above, the input to review selector 317 may include model predicted 3D annotations and class-agnostic heuristic functions 402. The model predicted annotations may include the initial bounding boxes or masks generated by an object detection model for potential objects in the scene. These annotations may be in 3D space, considering the pointcloud data. Class-agnostic heuristic functions 402 may analyze features like edges in images or normals in point clouds to identify potential objects without classifying them (i.e., without classifying an object as a car or a pedestrian). The review selector 317 may refine the initial model predictions by providing a more accurate RoI proposal as an output. Such proposal could be a more precise bounding box or a refined mask around the object. Review selector 317 may assign a score or measure indicating how much improvement the annotation needs. A high score may suggest significant refinement is necessary, while a low score may suggest the annotation is relatively accurate. A combination of the refineability score and other factors may guide the decision of the annotator on how much effort to dedicate to refining the annotation. Output of the review selector 317 may also include specific details about which aspects of the annotation need refinement. Review selector 317 may highlight specific objects in the scene that require attention. This could be done by highlighting the bounding boxes or masks. Review selector 317 may pinpoint what needs improvement within the annotation. As an example, a bounding box may need improvement if the size or position of the box needs adjustment. Classification may need improvement if the model assigned the wrong class label (e.g., mistaking a car for a pedestrian). As yet another example, attributes may need improvement if additional information about the object needs correction, such as its orientation or size.

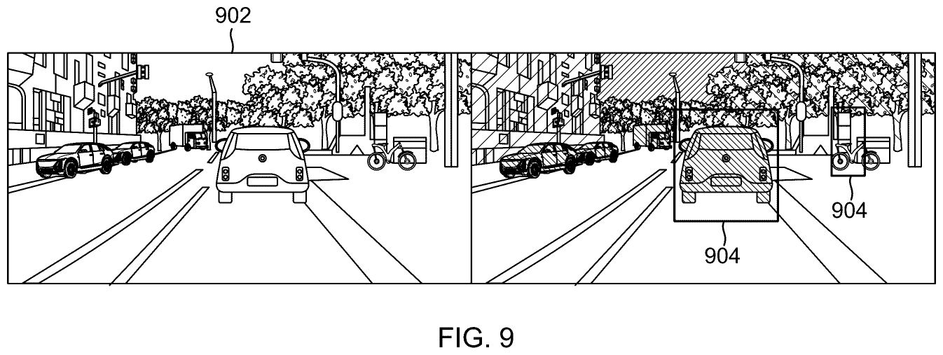

FIG. 9 illustrates a sample image 902 and class-agnostic objectness based ROI proposal 904 in accordance with the techniques of this disclosure. The goal of review selector 317 may be to identify regions of interest (RoIs) that likely contain object boundaries, regardless of the object type. Review selector 317 may employ unsupervised techniques like the Canny edge detector or Sobel filter that may be used to identify sharp changes in intensity in an image, which often correspond to object boundaries. Advanced techniques like deep learning models trained on unlabeled datasets may also be used. The deep learning models may learn to identify salient edges that may not be captured by traditional approaches. Review selector 317 may use optical flow techniques to analyze changes in pixel intensity between consecutive video frames. Areas with significant motion may indicate object boundaries. Review selector 317 may employ unsupervised techniques for motion segmentation to group pixels with similar motion patterns, potentially revealing object boundaries. LiDAR data may provide information about the surface orientation at each point. Sudden changes in these normals may indicate potential object boundaries. Review selector 317 may also use techniques like normal discontinuity detection or clustering normals with similar orientation to identify RoI regions 904 with likely object boundaries.

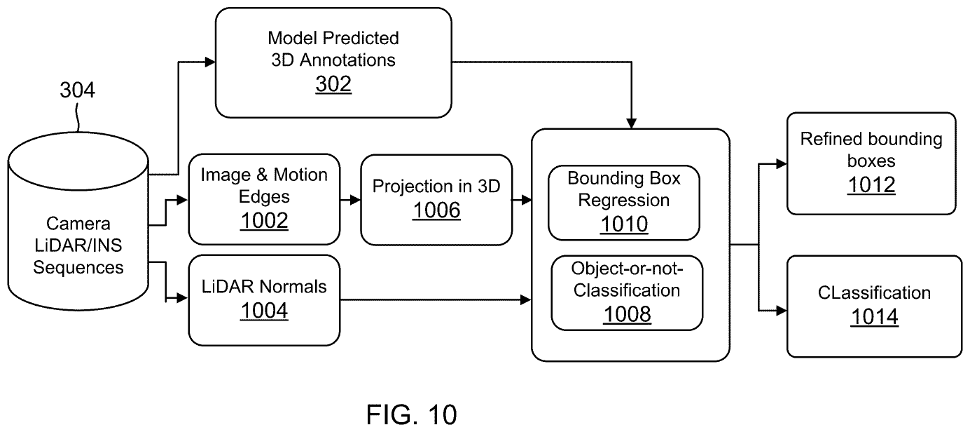

FIG. 10 is a block diagram of class-agnostic objectness based detection processing in accordance with the techniques of this disclosure. Referring to FIG. 10, sensor data 304 may be a combined data stream from the vehicle's camera, LiDAR sensor, and INS. Camera data may provide visual information about the scene. LiDAR data may create a 3D point cloud representing the environment. INS data may track the position and orientation of the vehicle. A deep learning model may be used to analyze the sensor data and generate initial bounding boxes 302 for potential objects in 3D space. Review selector 317 may extract edges from camera images using techniques like Canny edge detection. Motion edges 1002 may be identified by analyzing changes in pixel intensity between video frames (optical flow). Review selector 317 may calculate the surface orientation 1004 at each point in the LiDAR point cloud. Information from image and motion edges may be projected 1006 onto the 3D point cloud to potentially refine the location of object boundaries. The review selector 317 may refine 1010 the initial 3D bounding boxes (predicted by the model or based on other data) to improve their accuracy. The review selector 317 may classify 1008 each proposed bounding box as either containing an object or not. The final output of review selector 317 may consist of refined 3D bounding boxes 1012 and a classification 1014 for each box (object or not). Based on certain criteria (e.g., confidence score of the classification), the review selector 317 may recommend specific bounding boxes for human review to ensure accuracy.

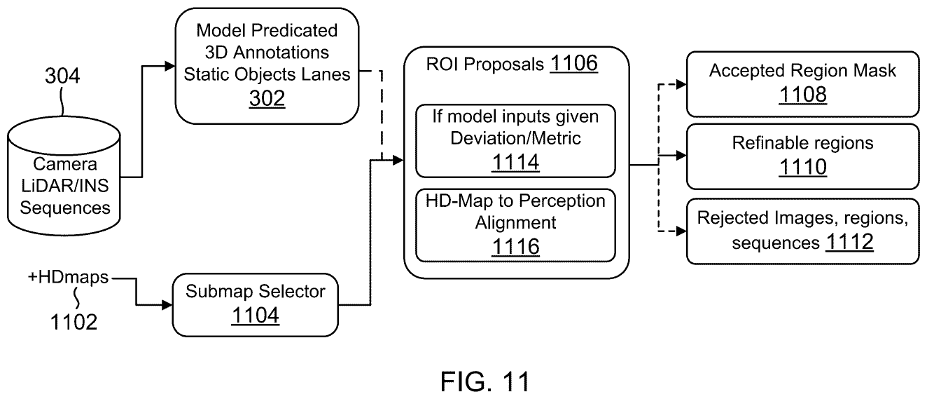

FIG. 11 is a block diagram illustrating a high definition (HD) map-based RoI technique in accordance with the techniques of this disclosure. By leveraging HD Maps, the review selector 317 may precisely locate the vehicle within its environment. This precise location may be important for aligning other sensor data and predictions. The HD Map may contain detailed information about static objects (like traffic signs, buildings) and lane markings. The information about static objects may be used to align the 3D model predictions from the sensors of the vehicle (camera, LiDAR) with the actual environment. This alignment may help to improve the accuracy of the 3D object detection. The alignment may also identify potential errors or inconsistencies in the sensor data. HD Maps are a reliable source of information about static elements in the environment. The information provided by HD maps may be used to “pre-populate” the review selector's 317 understanding of the scene, reducing reliance solely on real-time sensor data. By aligning the HD Map data with the perception stream (sensor data and predictions), the review selector 317 may generate RoIs with additional information. The type of object within the RoI may be identified using the HD Map data (e.g., traffic light, stop sign, crosswalk). The HD map may provide confirmation of the existence of the object in that location, enhancing the confidence of the review selector 317 in the RoI.

Referring to FIG. 11, sensor data 304 may be a combined data stream from the vehicle's camera, LiDAR sensor, and INS. Camera data may provide visual information about the scene. LiDAR data may create a 3D point cloud representing the environment. INS data may track the position and orientation of the vehicle. An HD map 1102 may be a high-definition map containing detailed information about the environment, including static objects (traffic signs, buildings) and lane markings. A deep learning model may analyze the sensor data 304 to generate initial bounding boxes 302 for potential static objects and lane markings in 3D space. The submap selector 1104 may be used to select a relevant submap from the HD map 1102 that corresponds to the current location and driving direction of the vehicle. This submap may provide a more focused area for identifying RoIs. Based on the model predictions and the selected submap, the review selector 317 may generate RoI proposals 1106. The generated RoI proposals 1106 may be categorized as: accepted regions mask 1108, refinable regions 1110 and rejected images/regions/sequences 1112. The accepted regions mask 1108 may include regions in the scene confirmed as containing static objects or lanes (based on both model predictions and HD Map alignment). The refinable regions 1110 may be regions where the review selector 317 has some confidence about an object or lane, but further refinement may be needed (e.g., unclear boundaries). The rejected images/regions/sequences 1112 may include data points (images, regions, or entire sensor sequences) deemed unreliable or irrelevant for RoI generation. If additional information about the performance of the model is available, such as the deviation between its predictions and known ground truth, such information may be used to assess 1114 the accuracy of the model and to potentially refine the RoI proposals. The review selector 317 may evaluate the alignment 1116 between the HD Map data and the model predictions. This evaluation may help identify potential discrepancies and improve the overall reliability of the RoIs.

Compared to relying solely on sensor data, by using an HD map-based RoI detector, review selector 317 may significantly expand the range of objects a vehicle may identify. In addition to lanes, review selector 317 may now detect: lane markers (e.g., solid lines, dashed lines, double lines), curbs (separating road from sidewalk or shoulder), barriers (e.g., guardrails, median barriers), traffic signs and lights. For each detected object, the review selector 317 may extract rich information from the HD map 1102. For example, the type of object may be identified (e.g., stop sign, crosswalk, solid white line). The HD map 1102 may confirm the presence of the object in that location, boosting confidence in the detection. The HD map 1102 may provide precise information about the 3D location and shape of the object in the environment. The review selector 317 may utilize various metrics to ensure the accuracy and reliability of the RoI proposals 1106. 3D Intersection over Union (IoU) deviation metric may measure how well the bounding box of review selector 317 around an object overlaps with the actual object's shape in the HD map 1102 (considering 3D space). A low deviation may indicate good alignment. A lane alignment distance function metric may calculate the distance between the detected lane lines and the lane lines in the HD map 1102. A small distance may suggest accurate lane detection. The review selector 317 may consider lane width variations depending on the country or region. This ensures proper interpretation of lane markings considering local traffic regulations. The review selector 317 may check for consistency between the information from the camera and sensor data 304. This metric combined with other metrics like IoU deviation may help identify potential errors or inconsistencies in the sensor data 304.

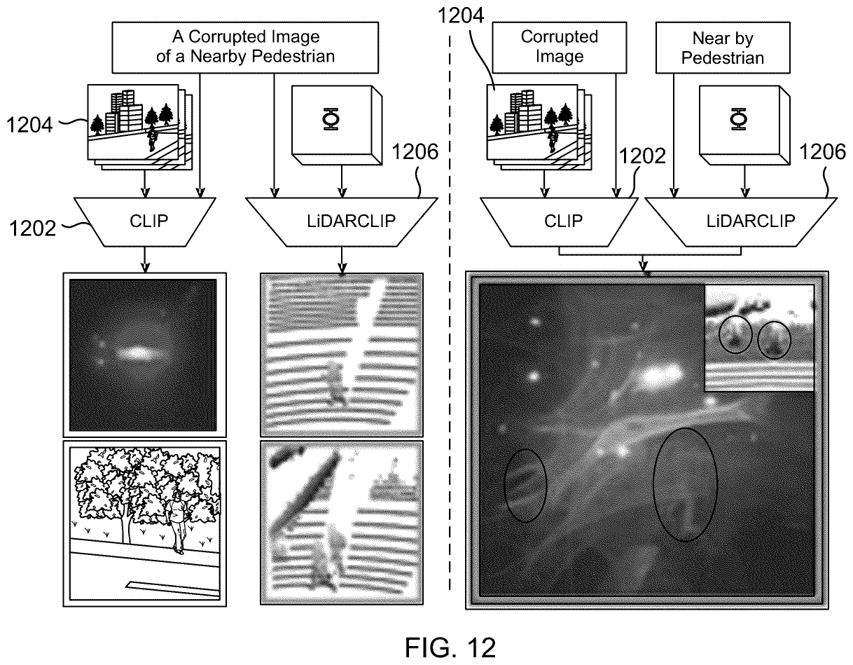

FIG. 12 illustrates a sample image using multi-modal embeddings in accordance with the techniques of this disclosure. Traditional RoI selection approaches rely solely on sensor data (camera, LiDAR) which may be susceptible to errors, especially in challenging conditions like light saturation or sensor malfunctions. Text-image multimodal embeddings technique may use models like CLIP (Contrastive Language-Image Pre-training) model 1202 to establish a connection between text descriptions and image data. The review selector 317 may be trained on a dataset of text descriptions paired with corresponding images of objects relevant to vehicles (e.g., “stop sign,” “traffic light,” “pedestrian”). During operation, the review selector 317 may: take an input image 1204 (possibly corrupted due to sensor issues) and may generate an embedding (a numerical representation) that captures the semantic content of the image; process a text query describing a potential object of interest (e.g., “find a yield sign”); utilize the CLIP model 1202 to compare the image embedding with the embedding generated from the text query. The CLIP model 1202 may help determine how well the image content matches the described object. Even if the input image has corruptions, the text query may guide the review selector 317 towards relevant regions. The review selector 317 may be queried for specific objects, potentially focusing on critical elements for safe driving. Pertinent input selection technique may help the review selector 317 choose the most relevant data points (images or LiDAR points) for further processing, even if the initial sensor data may be compromised. The disclosed technique may be extended beyond images. Techniques like LIDAR CLIP 1206 may be used to establish connections between text descriptions and 3D point cloud data (from LiDAR sensors). This technique may allow the review selector 317 to query the point cloud data using textual descriptions, potentially improving RoI selection in scenarios where camera data may be unreliable.

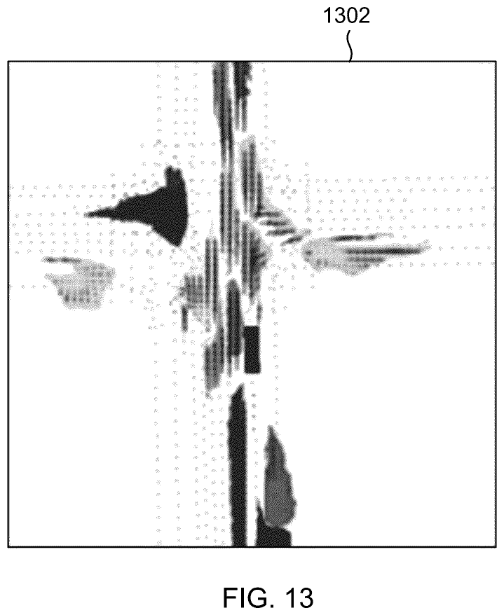

FIG. 13 illustrates a sample image 1302 using 3D scene flow estimation in accordance with the techniques of this disclosure. Trained Convolutional Neural Networks (CNNs) are the workhorse for object detection in self-driving vehicles. However, CNNs may struggle with rare objects or the objects with limited visual cues. Motion as a class-agnostic signal technique may utilize motion information to identify potential objects, regardless of their specific class (car, pedestrian, etc.). This technique may be particularly useful for rare objects that CNNs may not have encountered during training. Scene flow may analyze changes in pixel intensity between consecutive video frames, revealing motion patterns. Occupancy flow may build a grid or point-wise map where each cell may indicate the likelihood of that space being occupied by a moving object. The aforementioned motion information may provide a complementary perspective to traditional CNN-based object detection. Areas with significant motion may indicate the presence of an object, even if its visual details are unclear. Such motion information may act as a failsafe mechanism, helping review selector 317 identify potential objects that CNNs may miss. By combining motion cues with visual information, the review selector 317 may generate more accurate and comprehensive RoIs. This may ensure that even rare or unusual objects are flagged for further investigation.

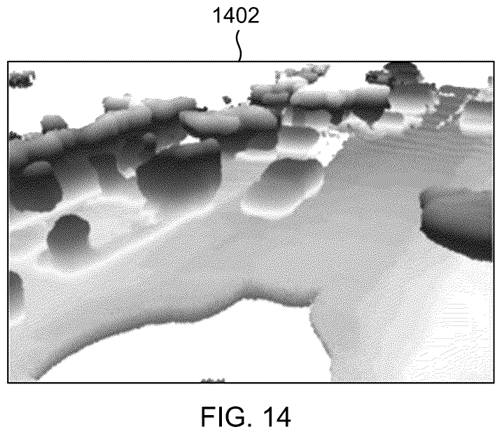

FIG. 14 illustrates a sample image using occupancy estimation in accordance with the techniques of this disclosure. Review selector 317 relies on various data sources like camera images and LiDAR point clouds. However, these sources may not explicitly tell review selector 317 if a specific region in space is actually occupied by an object. Occupancy estimation technique may introduce a self-supervised occupancy network. The self-supervised network may learn by analyzing the data itself, without needing pre-labeled data for object presence. The network may take LiDAR point cloud data as input and may predict the occupancy probability for each 3D point in space. The self-supervised network may utilize both local feature embeddings and global feature embeddings. The local feature embeddings may capture detailed information about the specific point and its surrounding points. The global feature embeddings may capture broader context about the overall scene. The occupancy network may provide a probabilistic estimate of whether each point is occupied by an object. This information may act as a prior, guiding the RoI selection process. Regions with a higher predicted occupancy likelihood may be more likely to contain objects. The review selector 317 may prioritize these regions for further analysis, leading to more efficient and accurate object detection. By filtering out regions with low occupancy probability, the review selector 317 may reduce the number of false positives (incorrectly identified objects). This reduction may help review selector 317 to focus computational resources on the most promising areas.

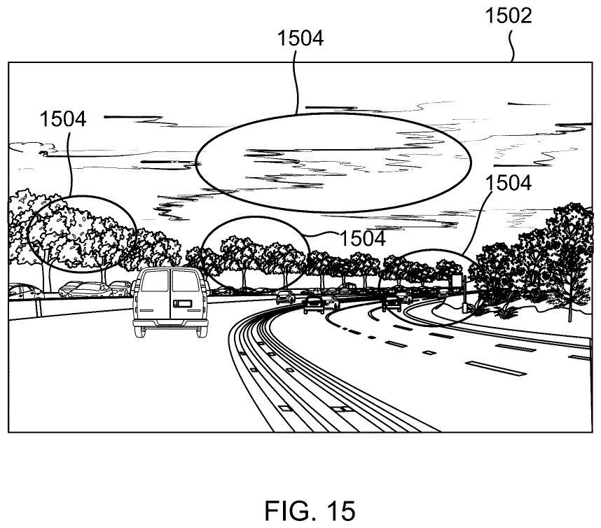

FIG. 15 illustrates a sample image 1502 of a rejection scenario. In vehicle perception, nondescript regions refer to areas in the surroundings of the vehicle that provide limited or irrelevant information for immediate navigation. The nondescript regions do not require significant processing power or focus from the vehicle's systems. Vehicles far away in adjacent lanes or on the other side of the highway are unlikely to interact with the vehicle in the immediate future. These vehicles may be classified as nondescript regions 1504 because their details are not important for immediate path planning. Similar to distant highway vehicles, parked vehicles are not actively moving and are unlikely to affect the path of the ego-vehicle. The parked vehicles may be considered nondescript for immediate navigation purposes. The sky region typically provides no relevant information for obstacle detection or path planning. The sky is a static element and may be classified as nondescript. Large empty areas, especially if they cover around 60% of the image, offer minimal information for immediate navigation. These large areas of nondescript regions 1504 may be flagged as nondescript to reduce processing burden on the review selector 317. By identifying nondescript regions 1504, the review selector 317 may focus its resources on areas with higher potential for containing relevant objects (like moving vehicles, pedestrians, traffic signs). The identified nondescript regions 1504 may improve processing efficiency and may reduce computational load. Less processing on nondescript regions 1504 may lead to fewer false positives (incorrect object detections) in those areas. This may allow the review selector 317 to prioritize real objects requiring attention.

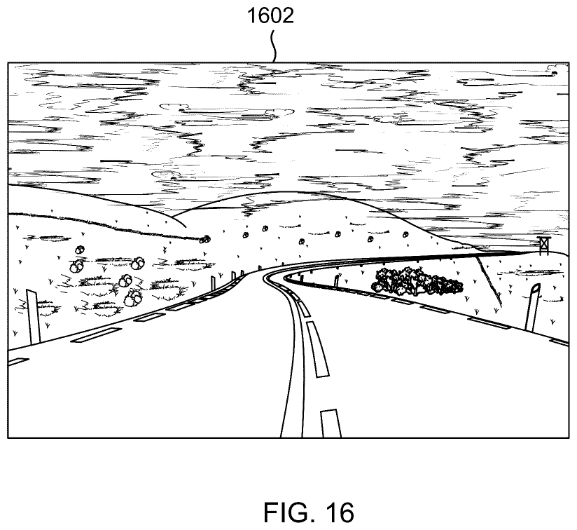

FIG. 16 illustrates a sample image 1602 of another rejection scenario. As noted above, the objectness measure count is a metric used to quantify the presence of objects within a frame. A high objectness measure count may indicate a frame containing multiple objects, while a low count may suggest a frame with few or no objects. In computer vision/perception context, frames lacking substantial content are often undesirable. In an aspect, review selector 317 may employ the objectness measure count to reject frames considered empty or with minimal content. Review selector 317 may define a threshold value for the objectness measure count. This threshold may determine the minimum number of objects required for a frame to be considered acceptable. For each frame, review selector 317 may calculate the total objectness measure count by summing the individual counts for each object within the frame. If a frame's total objectness measure count falls below the defined threshold, review selector 317 may consider the frame likely containing no objects or very few objects. Review selector 317 may categorize these frames for rejection. By following the aforementioned steps, review selector 317 may effectively select frames for rejection based on their objectness measure count, ensuring to focus on frames containing significant visual content.

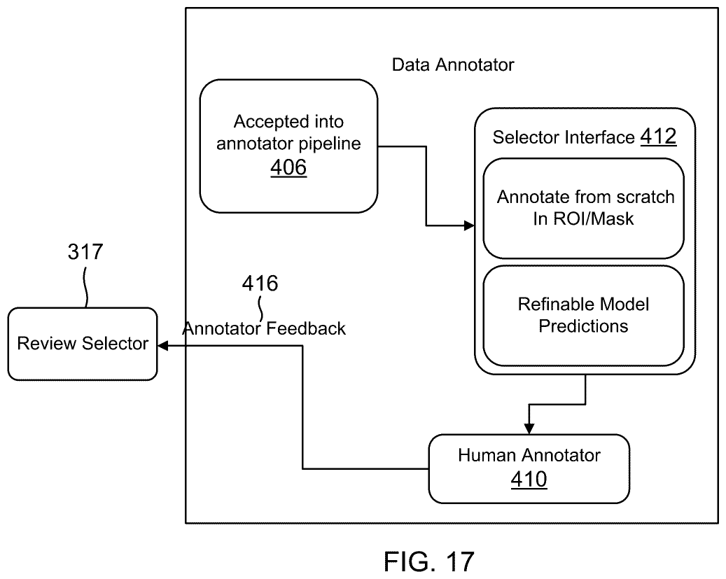

FIG. 17 is a block diagram illustrating external data annotator processing in accordance with the techniques of this disclosure. In the context of image annotation, selector interface 412 may be used to present frames or RoIs to human annotators 410 for review and refinement. Feedback 416 may include accepted model predictions (false positives). False positives may occur when the model generates a bounding box (RoI) around an area that does not actually contain an object (false positive). The annotator 410 may confirm this but may also provide additional information on why the model prediction is incorrect. The annotator 410 may refine an existing RoI proposed by the model. The refinement may involve adjusting the bounding box size or position to more accurately encompass the intended object. The annotator 410 may identify objects the model missed entirely. The annotator 410 may create new RoIs to capture these missing objects. By analyzing feedback 416 provided by annotators 410 via interface 412, review selector 317 may be improved. Annotator corrections on consistently accepted model predictions (false positives) may reveal biases in the model. For instance, the model may constantly generate RoIs around specific irrelevant features. This feedback 416 may be used to retrain the model to avoid such biases. If certain types of objects are frequently marked as missing RoIs or require significant corrections, the model may struggle with those categories. The selector interface 412 may be adjusted to prioritize presenting these challenging cases to the annotators 410 for focused training data improvement. Feedback 416 on corrected RoIs may inform the design of tools within the selector interface 412 to assist with adjustments. This could involve tools for easy box resizing or shape selection. If annotators consistently reject specific types of frames (low object count), the review selector 317 may be programmed to filter out such frames in the future, saving annotator time. The ultimate objective is to create the selector interface 412 that efficiently presents the most informative and challenging cases to human annotators 410. The illustrated feedback loop may allow the review selector 317 to learn from annotator expertise and continuously improve its object detection capabilities.

The quality of the review selector 317 may be effectively determined through an evaluation process that leverages annotator feedback 416 and a feedback loop incorporating that data. One of the indicators of an effective review selector 317 may be a decrease in the time and effort required by annotators 410 to complete their tasks. This could be measured by tracking the average time spent reviewing frames, the number of frames rejected due to low object count, or the frequency with which missing RoIs are identified. As the review selector 317 prioritizes relevant and challenging cases, the overall accuracy of the annotations should increase. The accuracy may be measured by comparing the agreement between annotators and the model's predictions before and after incorporating feedback loops. Surveys or direct feedback from annotators 410 may gauge their satisfaction with the selector interface 412. Ease of use, clarity of presented information, and effectiveness in guiding the annotators towards the most valuable cases are all aspects to consider. During the evaluation, annotator feedback 416 on accepted model predictions (false positives), corrected RoIs, missing RoIs, and overall workflow efficiency may be collected. The collected data may be analyzed to identify patterns and trends. The analysis may involve looking for consistently flagged model biases, types of objects frequently missed, or areas where the interface hinders the annotation process. Based on the analysis, the review selector 317 may then be refined. Refining the review selector 317 may involve, but is not limited to: retraining the model to address identified biases, adjusting the selection criteria to prioritize challenging cases for specific object categories, integrating new tools within the interface to assist with RoI adjustments, implementing filtering mechanisms to reduce irrelevant frames. The refined review selector 317 may then be re-evaluated using a fresh dataset with new annotators or with the same annotators to assess the impact of the improvements. A designated evaluation dataset is important for this process. The evaluation dataset should be representative of the real-world data the review selector 317 may encounter and should be independent of the data used to train the review selector 317 itself. This may ensure the evaluation reflects how well the review selector 317 performs on unseen data.

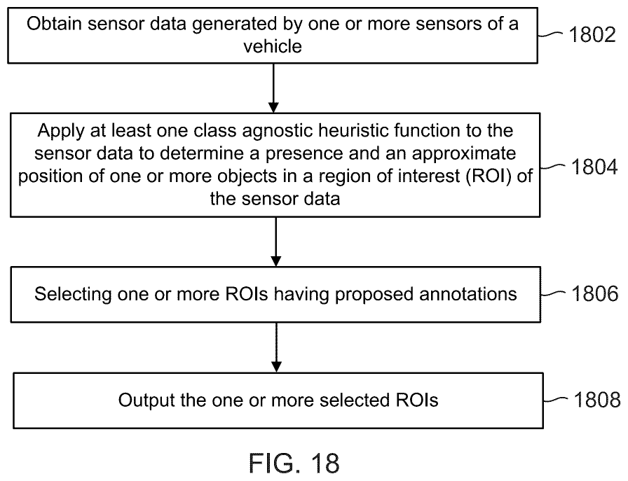

FIG. 18 is a flowchart illustrating an example method for semi-automatic perception annotation in accordance with the techniques of this disclosure. Although described with respect to computing system 200 (FIG. 2), it should be understood that other computing devices may be configured to perform a method similar to that of FIG. 18.

At block 1802, review selector 317 may obtain sensor data generated by one or more sensors of a vehicle.

At block 1804, review selector 317 may apply at least one class-agnostic heuristic function to the sensor data to determine a presence and an approximate position of one or more objects in a RoI of the sensor data.

At block 1806, review selector 317 may select one or more RoIs having proposed annotations for the one or more objects that may potentially require for refinement by an annotator.

At block 1808, review selector 317 may output the one or more selected RoIs. In an example, outputting the one or more selected RoIs may include sending the one or more selected RoIs to the annotator.

Thus, the techniques of this disclosure use class-agnostic functions based only on unsupervised/non-annotated perception data, to determine RoIs for human annotations and use the combination of a model's pre-annotations and class-agnostic functions to select RoIs along with pre-annotations for human refinement. The adaptive annotation framework described herein provides for a large improvement in the overall annotation quality by incorporating a semi-automatic supervision for manual annotation.

The following numbered clauses illustrate one or more aspects of the devices and techniques described in this disclosure.

Clause 1. A method for selecting one or more Regions of Interest (RoIs) for human annotations includes obtaining sensor data generated by one or more sensors of a vehicle; applying at least one class-agnostic heuristic function to the sensor data to determine a presence and an approximate position of one or more objects in an RoI of the sensor data; selecting one or more RoIs having proposed annotations for the one or more objects for refinement by an annotator; and outputting the one or more selected RoIs.

Clause 2. The method of clause 1, further comprising: applying a machine learning model to the sensor data to generate predicted annotations and one or more proposed RoIs; and analyzing the predicted annotations to generate the proposed annotations and to selectively refine, prior to outputting, the one or more proposed RoIs.

Clause 3. The method of clause 1, wherein applying the at least one class-agnostic heuristic function comprises: determining the presence and the approximate position of the one or more objects using a corresponding High Definition (HD) map.

Clause 4. The method of any of clauses 1-3, wherein applying the at least one class-agnostic heuristic function comprises: calculating a respective objectness measure count for each of a plurality of frames of the sensor data, wherein the respective objectness measure count is indicative of the presence of objects within a corresponding frame; and rejecting one or more of the plurality of frames based on the respective objectness measure count.

Clause 5. The method of any of clauses 1-4, wherein applying the at least one class-agnostic heuristic function comprises: detecting one or more areas with one or more moving objects to determine the approximate position of the one or more objects.

Clause 6. The method of clause 5, wherein detection the one or more areas comprises: analyzing changes in pixel intensity between two or more video frames to identify one or more motion edges.

Clause 7. The method of any of clauses of 1-6, wherein applying the at least one class-agnostic heuristic function comprises: determining shape of the one or more objects to determine the approximate position of the one or more objects.

Clause 8. The method of clauses of 1-7, wherein outputting the one or more selected RoIs comprises: sending the one or more selected RoIs via an interface used by the annotator.

Clause 9. An apparatus for selecting one or more Regions of Interest (RoIs) for human annotations, the apparatus comprising: a memory for storing sensor data; and processing circuitry in communication with the memory, wherein the processing circuitry is configured to: obtain the sensor data generated by one or more sensors of a vehicle; apply at least one class-agnostic heuristic function to the sensor data to determine a presence and an approximate position of one or more objects in an RoI of the sensor data; select one or more RoIs having proposed annotations for the one or more objects for refinement by an annotator; and output the one or more selected RoIs.

Clause 10. The apparatus of clause 9, wherein the processing circuitry is further configured to: apply a machine learning model to the sensor data to generate predicted annotations and one or more proposed RoIs; and analyze the predicted annotations to generate the proposed annotations and to selectively refine, prior to outputting, the one or more proposed RoIs.

Clause 11. The apparatus of clause 9, wherein the processing circuitry configured to apply the at least one class-agnostic heuristic function is further configured to: determine the presence and the approximate position of the one or more objects using a corresponding High Definition (HD) map.

Clause 12. The apparatus of any of clauses 9-11, wherein the processing circuitry configured to apply the at least one class-agnostic heuristic function is further configured to: calculate a respective objectness measure count for each of a plurality of frames of the sensor data, wherein the respective objectness measure count is indicative of the presence of objects within a corresponding frame; and reject one or more of the plurality of frames based on the respective objectness measure count.

Clause 13. The apparatus of any of clauses 9-12, wherein the processing circuitry configured to apply the at least one class-agnostic heuristic function is further configured to: detect one or more areas with one or more moving objects to determine the approximate position of the one or more objects.

Clause 14. The apparatus of clause 13, wherein the processing circuitry configured to detect the one or more areas is further configured to: analyze changes in pixel intensity between two or more video frames to identify one or more motion edges.

Clause 15. The apparatus of any of clauses 9-14, wherein the processing circuitry configured to apply the at least one class-agnostic heuristic function is further configured to: determine shape of the one or more objects to determine the approximate position of the one or more objects.

Clause 16. The apparatus of any of clauses 9-15, wherein the processing circuitry configured to output the one or more selected RoIs is further configured to: send the one or more selected RoIs via an interface used by the annotator.

Clause 17. Non-transitory computer-readable storage media having instructions encoded thereon, the instructions configured to cause processing circuitry to: obtain the sensor data generated by one or more sensors of a vehicle; apply at least one class-agnostic heuristic function to the sensor data to determine a presence and an approximate position of one or more objects in an RoI of the sensor data; select one or more RoIs having proposed annotations for the one or more objects for refinement by an annotator; and output the one or more selected RoIs.

Clause 18. The non-transitory computer-readable storage media of clause 17, wherein the processing circuitry is further configured to: apply a machine learning model to the sensor data to generate predicted annotations and one or more proposed RoIs; and analyze the predicted annotations to generate the proposed annotations and to selectively refine, prior to outputting, the one or more proposed RoIs.

Clause 19. The non-transitory computer-readable storage media of clause 17, wherein the processing circuitry configured to apply the at least one class-agnostic heuristic function is further configured to: determine the presence and the approximate position of the one or more objects using a corresponding High Definition (HD) map.

Clause 20. The non-transitory computer-readable storage media of any of clauses 17-19, wherein the processing circuitry configured to apply the at least one class-agnostic heuristic function is further configured to: calculate a respective objectness measure count for each of a plurality of frames of the sensor data, wherein the respective objectness measure count is indicative of the presence of objects within a corresponding frame; and reject one or more of the plurality of frames based on the respective objectness measure count.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media may include one or more of random-access memory (RAM), read-only memory (ROM), electrically erasable ROM (EEPROM), compact disc ROM (CD-ROM) or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method for selecting one or more Regions of Interest (RoIs) for human annotations comprising:
obtaining sensor data generated by one or more sensors of a vehicle;
applying at least one class-agnostic heuristic function to the sensor data to determine a presence and an approximate position of one or more objects in an RoI of the sensor data;
selecting one or more RoIs having proposed annotations for the one or more objects for refinement by an annotator; and
outputting the one or more selected RoIs.

2. The method of claim 1, further comprising:
applying a machine learning model to the sensor data to generate predicted annotations and one or more proposed RoIs; and
analyzing the predicted annotations to generate the proposed annotations and to selectively refine, prior to outputting, the one or more proposed RoIs.

3. The method of claim 1, wherein applying the at least one class-agnostic heuristic function comprises:
determining the presence and the approximate position of the one or more objects using a corresponding High Definition (HD) map.

4. The method of claim 1, wherein applying the at least one class-agnostic heuristic function comprises:
calculating a respective objectness measure count for each of a plurality of frames of the sensor data, wherein the respective objectness measure count is indicative of the presence of objects within a corresponding frame; and
rejecting one or more of the plurality of frames based on the respective objectness measure count.

5. The method of claim 1, wherein applying the at least one class-agnostic heuristic function comprises:
detecting one or more areas with one or more moving objects to determine the approximate position of the one or more objects.

6. The method of claim 5, wherein detection the one or more areas comprises:
analyzing changes in pixel intensity between two or more video frames to identify one or more motion edges.

7. The method of claim 1, wherein applying the at least one class-agnostic heuristic function comprises:
determining shape of the one or more objects to determine the approximate position of the one or more objects.

8. The method of claim 1, wherein outputting the one or more selected RoIs comprises:
sending the one or more selected RoIs via an interface used by the annotator.

9. An apparatus for selecting one or more Regions of Interest (RoIs) for human annotations, the apparatus comprising:
a memory for storing sensor data; and
processing circuitry in communication with the memory, wherein the processing circuitry is configured to:
obtain the sensor data generated by one or more sensors of a vehicle;
apply at least one class-agnostic heuristic function to the sensor data to determine a presence and an approximate position of one or more objects in an RoI of the sensor data;
select one or more RoIs having proposed annotations for the one or more objects for refinement by an annotator; and
output the one or more selected RoIs.

10. The apparatus of claim 9, wherein the processing circuitry is further configured to:
apply a machine learning model to the sensor data to generate predicted annotations and one or more proposed RoIs; and
analyze the predicted annotations to generate the proposed annotations and to selectively refine, prior to outputting, the one or more proposed RoIs.

11. The apparatus of claim 9, wherein the processing circuitry configured to apply the at least one class-agnostic heuristic function is further configured to:
determine the presence and the approximate position of the one or more objects using a corresponding High Definition (HD) map.

12. The apparatus of claim 9, wherein the processing circuitry configured to apply the at least one class-agnostic heuristic function is further configured to:
calculate a respective objectness measure count for each of a plurality of frames of the sensor data, wherein the respective objectness measure count is indicative of the presence of objects within a corresponding frame; and
reject one or more of the plurality of frames based on the respective objectness measure count.

13. The apparatus of claim 9, wherein the processing circuitry configured to apply the at least one class-agnostic heuristic function is further configured to:
detect one or more areas with one or more moving objects to determine the approximate position of the one or more objects.

14. The apparatus of claim 13, wherein the processing circuitry configured to detect the one or more areas is further configured to:
analyze changes in pixel intensity between two or more video frames to identify one or more motion edges.

15. The apparatus of claim 9, wherein the processing circuitry configured to apply the at least one class-agnostic heuristic function is further configured to:
determine shape of the one or more objects to determine the approximate position of the one or more objects.

16. The apparatus of claim 9, wherein the processing circuitry configured to output the one or more selected RoIs is further configured to:
send the one or more selected RoIs via an interface used by the annotator.

17. Non-transitory computer-readable storage media having instructions encoded thereon, the instructions configured to cause processing circuitry to:
obtain the sensor data generated by one or more sensors of a vehicle;
apply at least one class-agnostic heuristic function to the sensor data to determine a presence and an approximate position of one or more objects in an RoI of the sensor data;
select one or more RoIs having proposed annotations for the one or more objects for refinement by an annotator; and
output the one or more selected RoIs.

18. The non-transitory computer-readable storage media of claim 17, wherein the processing circuitry is further configured to:
apply a machine learning model to the sensor data to generate predicted annotations and one or more proposed RoIs; and
analyze the predicted annotations to generate the proposed annotations and to selectively refine, prior to outputting, the one or more proposed RoIs.

19. The non-transitory computer-readable storage media of claim 17, wherein the processing circuitry configured to apply the at least one class-agnostic heuristic function is further configured to:
determine the presence and the approximate position of the one or more objects using a corresponding High Definition (HD) map.

20. The non-transitory computer-readable storage media of claim 17, wherein the processing circuitry configured to apply the at least one class-agnostic heuristic function is further configured to:
calculate a respective objectness measure count for each of a plurality of frames of the sensor data, wherein the respective objectness measure count is indicative of the presence of objects within a corresponding frame; and
reject one or more of the plurality of frames based on the respective objectness measure count.
